(19) United States
(12) Patent Application Publication
(10) Pub. No.: US 2024/0212300 A1
(43) Pub. Date: Jun. 27, 2024

(54) SYSTEM FOR GENERATING BODY AND TATTOO ART

(71) Applicant: Cory James Koch, Austin, TX (US)

(72) Inventor: Cory James Koch, Austin, TX (US)

(21) Appl. No.: 18/390,808

(22) Filed: Dec. 20, 2023

Related U.S. Application Data
(60) Provisional application No. 63/476,689, filed on Dec. 22, 2022.

(51) Int. Cl. G06T 19/20; G06Q 30/0601; G06T 17/00

(52) U.S. Cl. CPC G06T 19/20; G06Q 30/0631; G06T 17/00; G06T 2200/24; G06T 2219/2012; G06T 2219/2024

(57) ABSTRACT

A system for generation of body art designs and artist recommendations. For example, the system may utilize textual descriptors, images, style selections, and design location to generate a plurality of potential designs for a user to apply as body art. In some cases, the system may allow for iterative refinement or regeneration of potential designs.

### CROSS-REFERENCE TO RELATED APPLICATION(S)

This application claims priority to U.S. Provisional Application No. 63/476,689 filed on Dec. 22, 2022 and entitled “System for Generating Tattoo Art,” which is incorporated herein by reference in its entirety.

### BACKGROUND

Selecting artwork for a tattoo or other body art is often a difficult and lifelong decision for an individual. Most individuals desire a unique work that represents them in a deeply personal manner. However, the decision conventionally involves manually browsing limited examples provided by the selected artist. This conventional manner in selecting artwork reduces the uniqueness and individualism of the selected designs. Accordingly, a better system for generating tattoo designs is desirable.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a design generation system for generating designs for use by an artist according to some implementations.

FIG. 2 is an example flow diagram showing an illustrative process for generating designs for application as body artwork according to some implementations.

FIG. 3 is an example flow diagram showing an illustrative process for training one or more machine learned models with respect to generating designs according to some implementations.

FIG. 4 is an example flow diagram showing an illustrative process for a user generating seed data for use in generating designs according to some implementations.

FIG. 5 is an example flow diagram showing an illustrative process for a presenting a design on a model of the user according to some implementations.

FIG. 6 is an example flow diagram showing an illustrative process for recommending an artist to generate and/or apply a design according to some implementations.

FIG. 7 is an example diagram of a cloud-based service associated with the design generation system according to some implementations.

FIG. 8 is an example diagram of a user system hosting a design generation application associated with the design generation system of FIGS. 1-7 according to some implementations.

FIG. 9 is an example pictorial diagram illustrating an example portion of a user interface of a design generation application associated with the design generation system of FIGS. 1-7 according to some implementations.

FIG. 10 is an example pictorial diagram illustrating an example portion of a user interface of a design generation application associated with the design generation system of FIGS. 1-7 according to some implementations.

FIG. 11 is an example pictorial diagram illustrating an example portion of a user interface of a design generation application associated with the design generation system of FIGS. 1-7 according to some implementations.

FIG. 12 is an example pictorial diagram illustrating an example portion of a user interface of a design generation application associated with the design generation system of FIGS. 1-7 according to some implementations.

FIG. 13 is an example pictorial diagram illustrating an example portion of a user interface of a design generation application associated with the design generation system of FIGS. 1-7 according to some implementations.

FIG. 14 is an example pictorial diagram illustrating an example portion of a user interface of a design generation application associated with the design generation system of FIGS. 1-7 according to some implementations.

FIG. 15 is an example pictorial diagram illustrating an example portion of a user interface of a design generation application associated with the design generation system of FIGS. 1-7 according to some implementations.

FIG. 16 is an example pictorial diagram illustrating an example portion of a user interface of a design generation application associated with the design generation system of FIGS. 1-7 according to some implementations.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Discussed herein are systems and methods associated with automating, generating, optimizing, customizing, and personalizing body art, tattoo designs, and/or other artwork. For example, a design generation system may be communicatively coupled to one or more systems, one or more machine learned models and/or one or more networks. Accordingly, the design generation system may be configured to receive from a user device one or more seed designs (or examples) that may be input into the one or more machine learned models and/or networks to generate a set of individualized or personalized tattoo or body art designs that the user may select from or provide to a preferred artist as the final design or as an input to the final design. In this manner, the design generation system may provide an individual with both a greater number of choices and more personalization when selecting a tattoo design.

In some implementations, the design generation system may be configured to access or receive third-party image data from various sources that may be used to train the one or more machine learned models and/or network or otherwise generate the set of individualized tattoo designs and/or body art. For example, the design generation system may access image stores (both associated with tattoos and/or body art as well as images in general) to receive third-party image data.

In some cases, the design generation system may also access publicly available images (such as via one or more WebCrawler or social media network) to identify actual images of tattoos and/or body art obtained, displayed, and shared by proud individuals. In some cases, the design generation system may apply a time threshold for the image data, such that the design generation system may stay current to contemporary trends and design movements. In some specific examples, the design generation system may include a team of human artists (e.g., such as regional, national, international teams that may provide both local designs and international designs) that provide images of tattoos and/or body art for use in training the one or more machine learned models and/or networks. For example, the design generation system may access, store, and utilize image data associated with tattoos and/or body art that were published within a threshold period of time (such as one year, two years, three years, and the like). In this manner, older designs may be phased out by the system so that the generated set of individualized tattoo designs stays meaningful and current to the industry. The design generation system may also access artist systems or datastores sharing artwork generated by practicing artists.

In some cases, a user accessing the design generation system may select a time period associated with the tattoo and/or body art. For example, the user may select a time period, such as an individual requesting medieval style tattoo may set a time period such as years and the system may generate examples appropriate for that time period. In another example, the user may select time periods such as the 1980s coupled with a geographic region, such as the United States of America, and the design generation system may provide example art that is representative of tattoos and body art produced within the 1980s and typically worn on individuals within the United States of America. As additional parameters, the user requesting the example artwork may provide art style, colors or palette, descriptive text or words (e.g., unicorn, sword that is on fire, waves, or the like), culturally influenced art, religion, and the like. In this example, the parameters input by the user may be in addition to or in lieu of example artwork uploaded to the design generation system. Accordingly, the input data including the parameters and any example artwork may be referred to herein as seed data.

In some cases, the set of individualized designs generated by the design generation system may be limited to a desired number of designs (such as ten, fifteen, twenty, or the like). In some cases, the design generation system may provide the individual, via a user interface of the user device, a first set of set of individualized designs to allow the individual to provide edits, comments, input, or the like. The design generation system may then, based at least in part on the edits, comments and/or input and the first set of individualized designs, generate a second set of individualized designs to further allow the individual to personalize the available choices prior to providing the selection to the preferred artist. In some cases, the design generation system may also include features to allow the preferred artist to provide input that may be reviewed and accepted or declined by the individual prior to generating the second set of individualized designs. In this manner, the system may allow the preferred artist to have creative input into the final or selected design(s).

In one example, the design generation system may also allow the individual to share the set of individualized designs with other users, such as the individual's family, friends, or the like. In these examples, the system may allow users approved by the individual to also provide edits, comments, input, or the like that the system may consider when generating the second set of individualized designs and/or a final selection. In some cases, the system may also be configured to project one or more of the second set of individualized designs onto an image of the individual's body at a location that the individual intends to implement the design, providing both the user and the other users a more realistic view of the final product.

In some cases, the design generation system may include one or more human rendering systems (e.g., via a game engine, three-dimensional modeling system, or the like) to generate three-dimensional models of the user that the user may interact with to move and place potential tattoos and/or body art on the user's actual body. For example, the human rendering systems may include systems or models for background segmentation and/or removal, avatar motion capture, three-dimensional human construction, and the like. In this example, the image data of the user may include video data of the user moving around an environment from multiple angles or capture points.

In various examples, any type of machine learning may be used consistent with this disclosure. For example, machine learning techniques may include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions (Naïve Bayes), color analyzing or processing techniques and/or a combination thereof.

As described herein, an exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine learning, which can refer to a broad class of such algorithms in which an output is generated based on learned parameters.

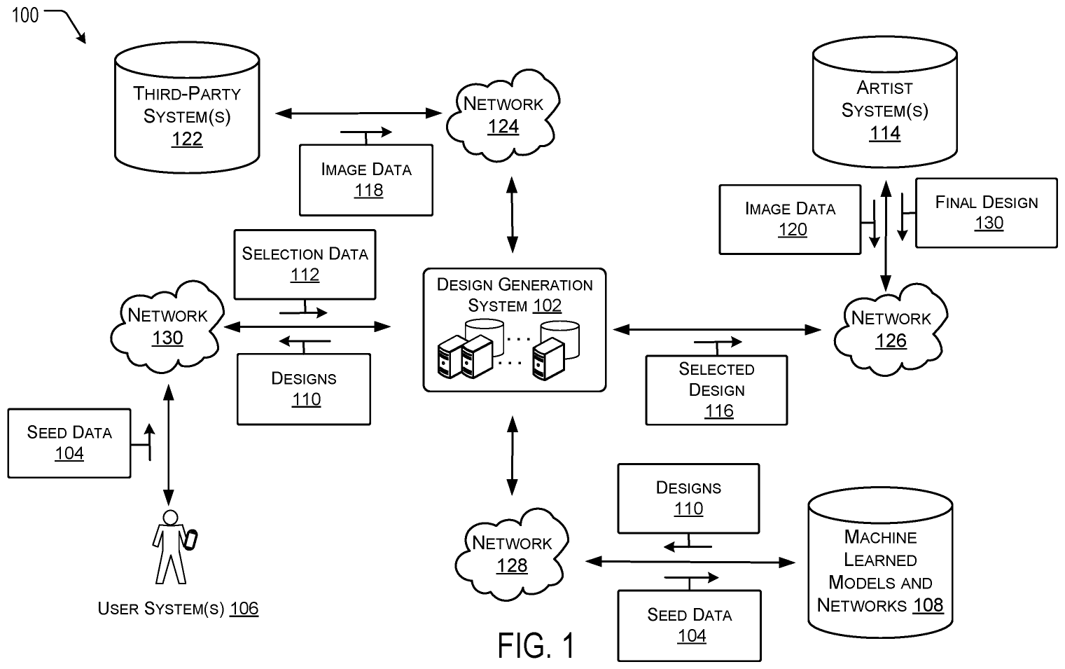

FIG. 1 is an example block diagram 100 of a design generation system 102 for generating designs for use by tattoo and/or body artists according to some implementations. In the current example, the design generation system 102 may receive seed data 104 from a user system 106, such as a smart phone, tablet, personal computer, or the like. The seed data 104 may include one or more images, characteristics or parameters (such as textual descriptors of the design), selection of prior or on-the-fly generated options of descriptors (such as type, content, features, style, era, texture, placement location or body location, realness, resolution, size, visual or camera features or settings, emotional feelings, and the like) that are representative of the design the user desires, influencing geographic regions, cultural or religious influences, period of time, or a combination thereof.

In some examples, the seed data 104 may also include images from friends, relatives, or other example tattoos or body art that the user enjoys, is familiar with, or wants to reference in generating their own designs 110. For example, a child may desire to have a similar body art to a parent and may include a photograph of the parent's design as part of the seed data 104. The seed data 104 may also include words, text, or content to be included such as phrases having specific meaning to the user or the like. In this manner, the text may be incorporated into the artwork of the design 104 during the design generation process, discussed herein.

In some implementations, the design generation system 102 may provide prompts or questions to the user via a hosted application on the user system 106 to obtain desired response and seed data 104 from the user, such as descriptors, characteristics, parameters, and even image data of the user, for use in generation of the designs 110. For example, the design generation system 102 may ask the user to describe in text the user's desired artwork. In some cases, the design generation system 102 may provide example clauses, words, text, image or the like that the user may incorporate, via a user interface on the user system 106 and associated with the hosted application, into the seed data 104. As another example, the user interface may include drop down menus, selections (e.g., pre-generated selectable descriptors, characteristics, and/or parameters) for use by the user when generating the seed data 104.

In some cases, the seed data 104 may also include body parts (e.g., descriptions, such as shoulder, stomach, biceps, or the like), skin color, palette, or tone selections (e.g., skin tones), demographic information (such as users cultural heritage), or the like. In still other examples, the seed data 104 my include images of body parts (e.g., actual image data of the user's body on which the tattoo or body art is to be placed) for the location of the body art. In some cases, the seed data 104 may include uploaded designs, images of actual designs, artwork, and the like and may be colored, grayscale, and/or black and white.

The design generation system 102 may input the seed data 104 into one or more machine learned models and/or networks 108. The machine learned models and/or networks 108 may then return or output designs 110 for the user. The designs 110 may include a set of designs for the user to select from. In some cases, multiple sets of designs may be generated and/or provided. In some cases, the designs 110 may be black and white, color, grayscale, or the like.

In one specific example, the design generation system 102 may generate three-dimensional (3D) models of the designs 110 which may be provided to the user system 106 and viewed or otherwise consumed by the user on, for instance, a 3D modeling system or interface associated with the system 102. In some cases, the 3D model designs 110 may be configured to receive images of the user's body or portions of the body at which the designs 110 are to be applied. In these cases, the design generation system 102 may generate 3D models of each design 110 that includes illustrating the design 110 on the user's body at the desired location or portion. In this manner, the user may, via the user system 106 and the design generation system 102, view or otherwise consume the designs 110 as the designs are projected to appear on the user's body. Accordingly, the user and/or the design generation system 102 may utilize any warping, deformation, or the like to the design caused by the application to the user's body. In some cases, the design generation system 102 may update the designs to accommodate for any deformation, such as when an autonomous or semi-autonomous device is applying the selected design 116 as body art.

In one specific example, the design generation system 102 may include one or more human rendering systems (e.g., via a game engine, three-dimensional modeling system, or the like) to generate three-dimensional models of the user that the user may interact with (e.g., control using a touch interface, mouse, stylus, or the like) to move and place the designs 110 as potential tattoos and/or body art on the user's actual body. For example, the human rendering systems may include systems or models for background segmentation and/or removal, avatar motion capture, three-dimensional human construction, and the like. In this example, the image data of the user may include video data of the user moving around an environment from multiple angles or capture points. In this manner, the user may place, remove, add, or otherwise view the designs 110 in a 3D model both of the user and the tattoo or other body art for a more realistic representation of the artwork when applied to the body of the user than in conventional systems.

As discussed herein, the design generation system 102 may provide the designs 110 to the user system 106. The user system 106 may include a user interface to allow the user to select, edit, comment, or otherwise provide feedback related to the designs, generally indicated by the selection data 112. Upon receiving the selection data 112, the design generation system 102 may either provide the selection data 112 to the machine learned models and/or networks 108 as additional seed data to receive another set of designs (e.g., to receive more designs 110 similar to the selected design 116 in an iterative design and generation process) or, if a design is selected, send the selected design 116 to an artist system 114 specified by the user via the seed data 104 or the selection data 112. For example, the user may specify a specific artist or artists in the seed data 104 and the machine learned models and/or networks 108 may utilize the artist as part of the data for generating the designs 110.

In some examples, the artist may be able to provide input for the user in response to receiving the selected design 116. For example, the artist may provide feedback that may improve the design, adjust the design for specific application locations or techniques, or otherwise provide an artistic input to the selected design 116. In these examples, the system may provide the input to the user system 106 to receive user approval of the suggested design edits. The design generation system 102 may also input the artist feedback into the one or more machine learned models and/or systems to generate another set of designs 110. In these example, the design generation system 102 may via an interface on the user system 106 suggest artists for the user or receive a user selection of an artist. For example, the design generation system 102 may generate a list of selectable or recommended artists for the user based on physical location (e.g., proximity between user and artist), style, design type or features (e.g., type, content, features, style, era, texture, cultural or religious influences, realness or realism, resolution, size, visual or camera features or settings, emotional feelings, portions of the design, and the like), art placement, orientation, location, or the like on the user's body, or the like.

In other examples, the artist system 114 may include automated, semi-autonomous, autonomous body art or tattooing machines, systems, or devices, or the like. In these examples, the selected design 116 may be provided to the body art system 114 and the system 114 may apply the design 116 to the user via various known image capture, processing, and control systems, such as machine learned systems.

In the current example, the one or more machine learned models and/or networks 108 may be trained using third party image data 118 as well as image data 120 received directly from artist systems 114. For example, the design generation system 102 may send requests to various third party systems 122 and/or artist systems 114 and receive the image data 118 and 120 in response. The system 102 may then utilize the received image data 118 and 120 to train the one or more machine learned models and/or networks 108 using various known automated and manual techniques.

In the current example, the seed data 104, designs 112, third-party image data 118, artist image data 120, selection data 112, and the like may be sent and/or received by the design generation system 102 via various networks, such as networks 124-130 as shown. In some cases, it should be understood that the networks 124-130 may be a single network or multiple combination of networks, as shown.

In the current example, the selected design 116 is provided to the user's selected artist system 114. However, it should be understood, that the artist system 114 may be an automated system or robotic system for placement of tattoos and/or body art on users. In other cases, the selected design 116 and/or the final design 130 ay be provided to the user that may personally provide the final designs to the selected artist, such as when the artist that created the final design 130 differs from the artist applying the design 130 to the user's body (e.g., such as based on geographical limitations or distances between the artist creating the final design 130 and the user).

In some examples, the system may also assist with selecting an artist for the user. For example, the design generation system 102 may utilize one or more additional machine learned models or heuristic based systems to select an artist for the user. For example, the artist may be selected based at least in part on a geographic region (or distance, such as designated by the user) from a location associated with the user (e.g., the home of the user). The system 102 may also consider artists styles, prior works, reputation or reviews (e.g., via the system 102 or external third-party reviews), and the like when selecting an artist to apply the selected design 116 and/or the final design 130. For example, the system 102 may determine a similarity score between the selected design 116 and/or the final design 130 and the prior work of each available artist within the designated geographic region, rank the available artist based on the scores, and to select one or more artists for recommendation to the user via the user system 106 based on the scores and/or the rankings.

In the current example, the artist preparing the final design 130, such as associated with the artist system 114, may differ from the artist selected by the design generation system 102 to apply the art to the user's body. For instance, the final design 130 may be generated by a first artist associated with the artist system 114. However, the first artist may be geographically distant from the user. In these case, the system 102 may recommend a nearby artist (e.g., within a selected distance and with similar skill or style to the first artist) to apply the final design 130 to the user, as discussed above.

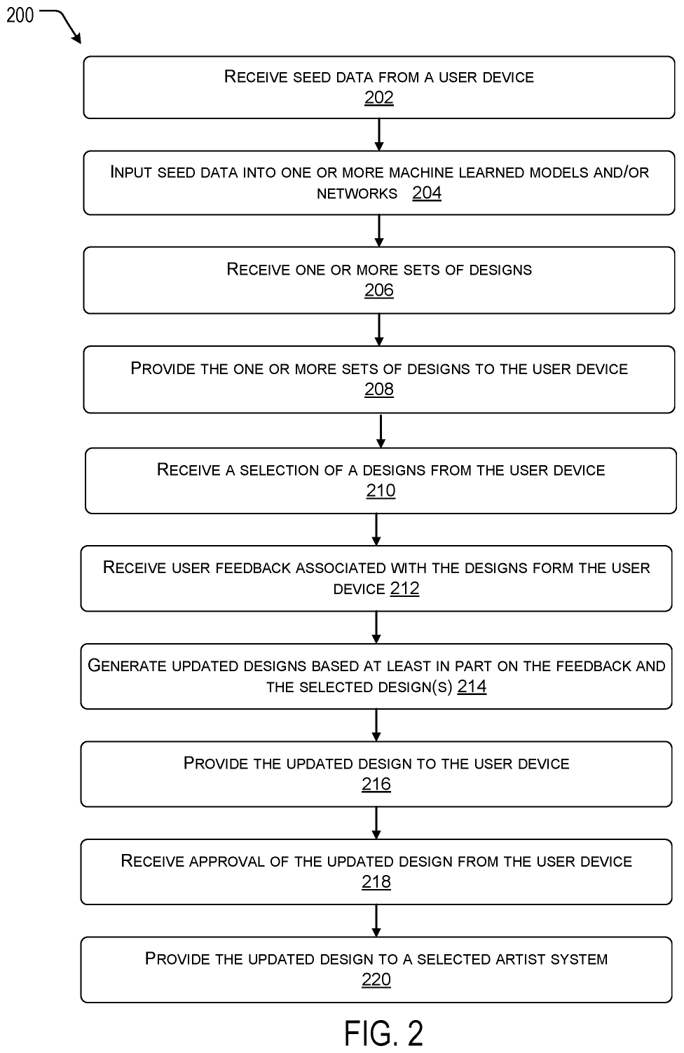

FIGS. 2-6 are flow diagrams illustrating example processes associated with the design generation system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is an example flow diagram showing an illustrative process for generating designs for body artwork according to some implementations. As discussed above, a design generation system may utilize one or more machine learned models and/or networks to generate sets of designs for a user to have greater choice and personalization with respect to their body art.

At 202, the design generation system may receive seed data from a user device. For example, the seed data may include one or more images or text that are representative of the design the user desires for the tattoo and/or body art. In some cases, the seed data may also include body parts (e.g., descriptions, such as shoulder, stomach, biceps, or the like) or images of body parts (e.g., actual image data of the user's body) for the location of the tattoo and/or body art. In some cases, the seed data 104 may include tattoo designs, images of actual tattoos, artwork, and the like and may be colored, limited spectrum or tone, or black and white. The seed data may include one or more characteristics or parameters (such as textual descriptors of the design), selection of prior or on-the-fly generated options of descriptors (such as type, content, features, style, era, texture, placement location or body location, realness, resolution, size, visual or camera features or settings, emotional feelings, and the like) that are representative of the design the user desires, influencing geographic regions, cultures, or religions, period of time or era, a combination thereof, or the like. In some cases, the seed data 104 may also include body descriptors (such as users cultural heritage, skin tone, hues, or the like, body parts, fitness level, age, sex, and the like).

In some examples, the design generation system may provide prompts or questions to the user via a hosted application on the user system to obtain desired response and seed data from the user, such as descriptors, characteristics, parameters, and even image data of the user, for use in generation of the designs. For example, the design generation system may ask the user to describe in text the user's desired artwork. In some cases, the design generation system may provide example clauses, words, text, images or the like that the user may incorporate, via a user interface on the user system 106 and associated with the hosted application, into the seed data. As another example, the user interface may include drop down menus, selections (e.g., pre-generated selectable descriptors, characteristics, and/or parameters) for use by the user when generating the seed data.

At 204, the design generation system may input the seed data into one or more machine learned models and/or networks. As discussed herein, the one or more machine learned models and/or networks may be trained using image data from third party sources, such as tattoo artists. In some cases, the machine learned models may be self-learning.

At 206, the design generation system may receive one or more sets of designs from the machine learned models and/or networks. For example, the seed data may be input into the machine learned network having multiple heads, such that the output of each head may be a design that may be combined into a set of designs related to the seed data.

At 208, the design generation system may provide the one or more sets of designs to the user device. For example, the system may send the designs as a set to the user device at which the user may view and/or interact with the designs, such as via a web-based or hosted application on the user device.

At 210, the design generation system may receive a selection of designs from the user device and, at 212, the design generation system may receive user feedback associated with the designs from the user device (such as additional seed data). In some cases, the selection may be one of the designs, a selection of multiple designs or the like. In some cases, the user feedback may include edits, highlights, comments, or the like.

At 214, the design generation system may generate updated designs based at least in part on the feedback and the selected designs. For example, the design generation system may input the feedback and the selected designs back into the machine learned models and/or networks or into additional machine learned models and/or networks to receive the updated designs as an output.

At 216, the design generation system may provide the updated designs to the user device and, at 218, the design generation system may receive approval of the updated design from the user device. If the system does not receive approval the process 200 may return to 212 and receive additional feedback on the updated designs to generate yet more updated designs using the additional feedback.

At 220, the design generation system may provide the updated design to a selected artist system. In some cases, the final design may simply be provided the user device and the user may deliver the final design to the artist. In some examples, the system may select the artist system based at least in part on the selected design, the seed data (or a portion thereof), a score or ranking associated with the works of the artist associated with the artist system and the selected design and/or seed data, or the like.

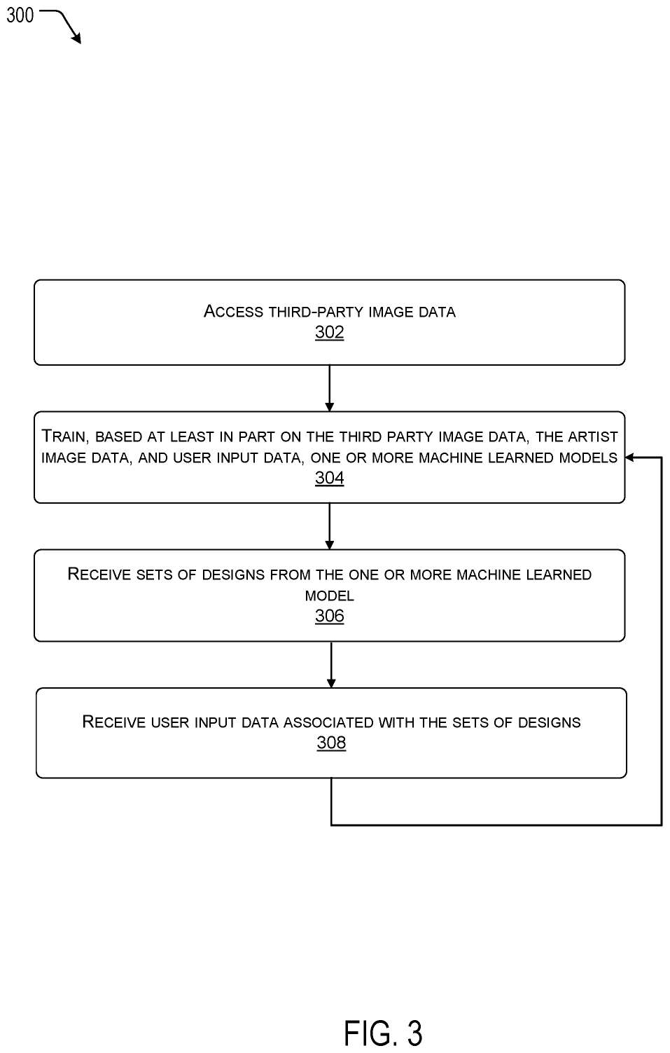

FIG. 3 is an example flow diagram showing an illustrative process 300 for training one or more machine learned models with respect to generating designs according to some implementations. As discussed above, a design generation system may utilize one or more machine learned models and/or networks to generate sets of designs for a user to have greater choice and personalization with respect to their body art.

At 302, the design generation system may access third party image data. For example, the image data may be images from artists, web-based images, photos of individuals body art, and the like. In some cases, the third party systems may be associated with artist systems registered with the design generation system.

At 304, the design generation system may train, based at least in part on the third party image data and user input data, one or more machine learned models. For example, the system may be trained using known manual or automated machine learning techniques.

At 306, the design generation system may receive sets of designs from the one or more machine learned models or networks and, at 308, the design generation system may receive user input data associated with the sets of designs. For example, the system may utilize the image data as an input and the user input data related to the output designs as additional input in order to train the design generation system.

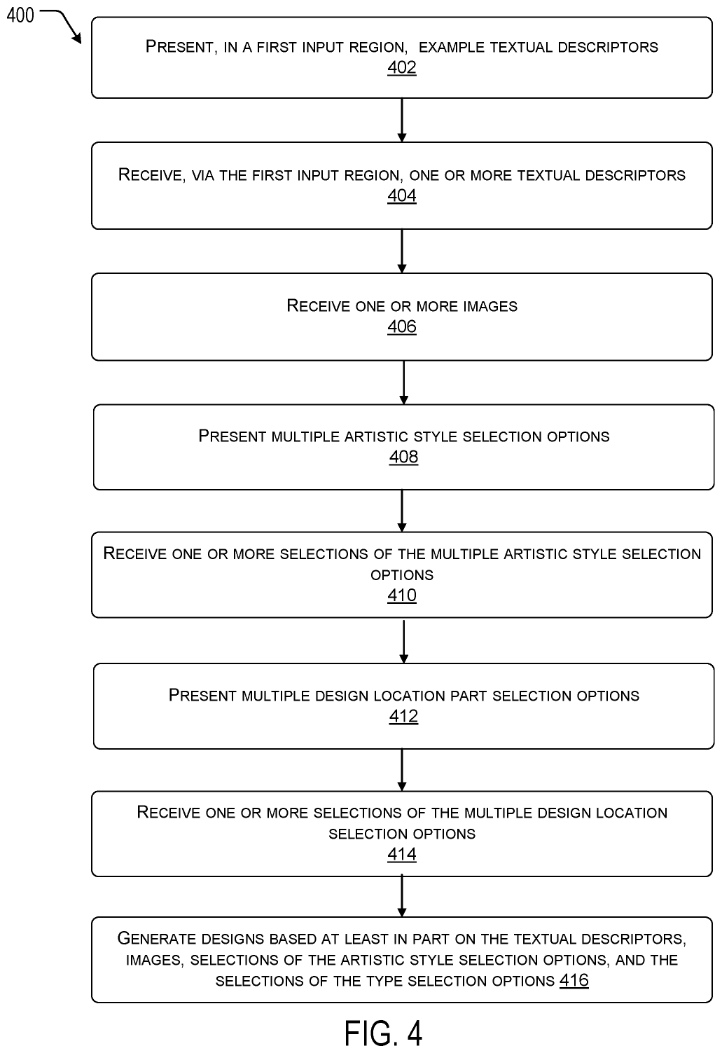

FIG. 4 is an example flow diagram showing an illustrative process 400 for a user generating seed data for use in generating designs according to some implementations. In some cases, the design generation system may be configured to assist the user in generating the seed data and/or include a wizard or assistant to support the user unfamiliar with cloud-based generative systems.

At 402, the system may present, in a first input region, example textual descriptors and, at 404, the system may receive, via the first input region, one or more textual descriptors. For example, the system may generate the example textual descriptors based on demographic information known about the user, such as via a user account. For example, the user may enter cultural heritage, home address or region, interests, age, sex, hobbies, employment information, and the like. In some cases, the design generation system may prepopulate the example textual descriptors based on known preferences for individuals that are similar to the user. For example, the system may know that individuals under the age of 25 living in the pacific region typical enjoy water based designs.

At 406, the system may receive one or more images. For example, each image may be representative of a style, topic, or design that the user desires. For example, the user may upload a pictures of birds of prey as the user may be interested in an eagle or hawk design.

At 408, the system may present multiple artistic style selection options and, at 410, the system may receive one or more selections of the multiple artistic style selection options. For example, the system may include styles such as realistic, cartoonish, nautical, traditional, neo-traditional, Japanese or Irezumi, biomechanical, dot work, geometric, chaotic, Chicano, illustrative, tribal, gothic, or the like. In some cases, the style selection options may also include options such as line color options (e.g., colored, grays scale options, pure black, watercolor, pastel), color vibrancy, color gradients, line thickness, shading options, font styles, font sizes, motifs, and the like.

At 412, the system may present multiple design location (e.g., a body part) selection options and, at 414, the system may receive one or more selections of the multiple design location selection options. For example, the design locations may include forearm, ankle, upper back, lower back, chest, and the like. In some cases, the design location selection options may allow for text based identification and/or a model based selection, in which the user may select an exact location based on a 2D or 3D model of a human body. In some cases, if a model of the user was generated, the model based selection may be relative to the model of their own body.

At 416, the system may generate designs based at least in part on the textual descriptors, images, selections of the artistic style selection options, and the selections of the type selection options. For example, the system may input the textual descriptors and images into one or more machine learned models that may include one or more parameters configured based at least in part on the selections of the artistic style selection options and the selections of the type selection options. In this example, the one or more machine learned models may be trained on other designs associated with the selections of the artistic style selection options and the selections of the type selection options. In this manner, the system may include different models for each combination of artistic style selection options and the type selection options. In some cases, the system may input the textual descriptors and/or images into multiple machine learned models, each model trained on different combination of selections of the artistic style selection options and the selections of the type selection options. For instance, a first model may generate Japanese style designs while a second may generate traditional designs and so forth.

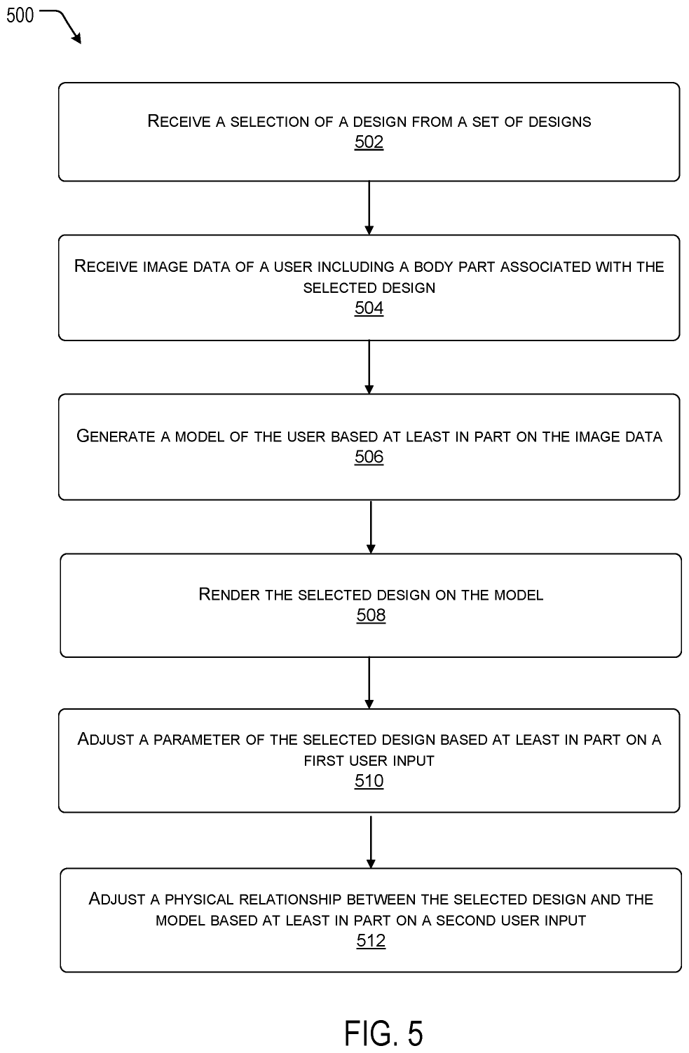

FIG. 5 is an example flow diagram showing an illustrative process 500 for presenting a design on a model of the user according to some implementations. In some examples, the design generation system may also allow for viewing of the design on a body of a human, such as the user. In some cases, the system may utilize a genetic model of various body parts but in the current example, the user may generate a model, such as a three-dimensional model, of their own body that the system may fit or warp the design to. In this manner, the user may view any potential design on the model of their body prior to committing to a specific design.

At 502, the system may receive a selection of a design from a set of designs. For example, the system may generate a set of designs for the user, as discussed herein. The user may then select one or more of the designs from the set for previewing via a human model, such as a model of their body.

At 504, the system may receive image data of a user including a body part associated with the selected design. The image data may include one or more still images and/or video data of the user. The image data may include an unobstructed view of the body part or parts that the user desires to model the selected design on. For example, if a user desires to model the selected design on their back then the user should have image data representing their back without a shirt on.

At 508, the system may generate a model of the user based at least in part on the image data. For example, the system may utilize a three dimensional game engine or rendering system to generate a three-dimensional model of the user. In other cases, the system may remove background data such as via feature identification, segmentation, and classification of the image data. The system may then generate two-dimensional and/or three-dimensional models using the segmented and classified feature data. As one illustrative example, the image data may be input in to one or more machine learned models and the output of the models may be the two-dimensional and/or three-dimensional models of the user and/or specific body parts.

At 508, the system may render the selected design on the model. For example, the system may fit or warp the selected design based on contours, shapes, colors, tones, or other features of the body part as determined in 506. In this manner, the selected design may be fit to the physical body of the user.

At 510, the system may adjust a parameter of the selected design based at least in part on a first user input. For example, the user may adjust a size, orientation, axis, color, shadow, shading, or the like associated with the selected design. It should be understood that the user may make multiple adjustments to each parameter as the user previews the selected design on a model of their body.

At 512, the system may adjust a physical relationship between the selected design and the model based at least in part on a second user input. For example, the user may adjust a position, body part, orientation, direction, or the like of the selected design with respect to the model. As one specific example, the user may mirror or reverse the selected design with respect to the model. It should be understood that the user may make multiple adjustments to each parameter as the user previews the selected design on a model of their body.

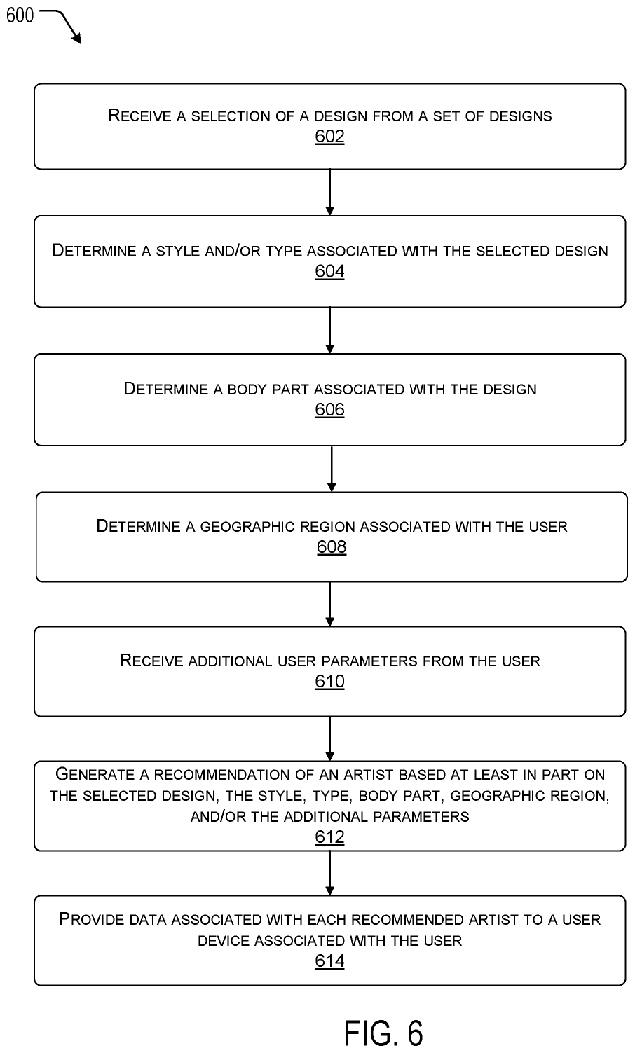

FIG. 6 is an example flow diagram showing an illustrative process 600 for recommending an artist to generate and/or apply a design according to some implementations. In some cases, the system may recommend an artist to finalize the design and/or apply the design on the body of the user. In some cases, the recommendation of the artist may be based on various criterion associated with the user as discussed below.

At 602, the system may receive a selection of a design from a set of designs. For example, the system may generate a set of designs for the user, as discussed herein. The user may then select one or more of the designs from the set for previewing via a human model, such as a model of their body.

At 604, the system may determine a style and/or type associated with the selected design. For example, different artists may specialize in different styles of types of body art. In these cases, the system may utilize the style and/or type selected by the user for generation of the selected design. In some cases, the system may determine the style and/or type based on the textual descriptors and/or the seed images provided by the user.

In some cases, the system may determine the style and/or type based on an analysis of the selected design. For instance, the selected design style may differ from the style that the user selected. For instance, during the updating or refining process the style of the final or selected design may begin to drift or vary from the originally selected style. As one example, the user may end up with a dot work design when they originally believed they wanted a tribal style design as the system iteratively generates designs for the user.

At 606, the system may determine a body part associated with the design. For example, the user may select the body part from a list or selectable option. In other cases, the system may determine the body part based on a selection from a human model paired with the selected design, as discussed above.

At 608, the system may determine a geographic region associated with the user. For example, the user may set a distance they are willing to travel to have the design applied. The system may then limit the artist recommendations to those within the user defined geographic distance. In some cases, the system may apply a geographic distance automatically such as within 100 miles of the user's home or the like.

At 610, the system may receive additional user parameters from the user. For example, the additional user parameters may include price range, years of experience, gender or sex, ratings thresholds, review thresholds, and the like. For example, the user may define a price range, such as less than a desired amount, and a minimum number of years of experience as prequalification for the recommendation process.

At 612, the system may generate a recommendation of an artist based at least in part on the selected design, the style, type, body part, geographic region, and/or the additional parameters. For example, the recommendation may be for a specific artist, a group of artists, and the like. In some cases, the recommendations may be ranked based at least in part on the proximity of the artist qualifications/credentials/experience to the selected design, the style, type, body part, geographic region, and/or the additional parameters.

At 614, the system may provide data associated with each recommended artist to a user device associated with the user. For example, for each recommended artist the system may provide a community input or profile page. In some cases, the profile page may include recommendations, ratings, reviews, and the like as well as example designs or applications performed and provided by the artist and/or other users. The profile page may also include bios, experience, and the like provided by the artist that the user may review prior to making a final decision.

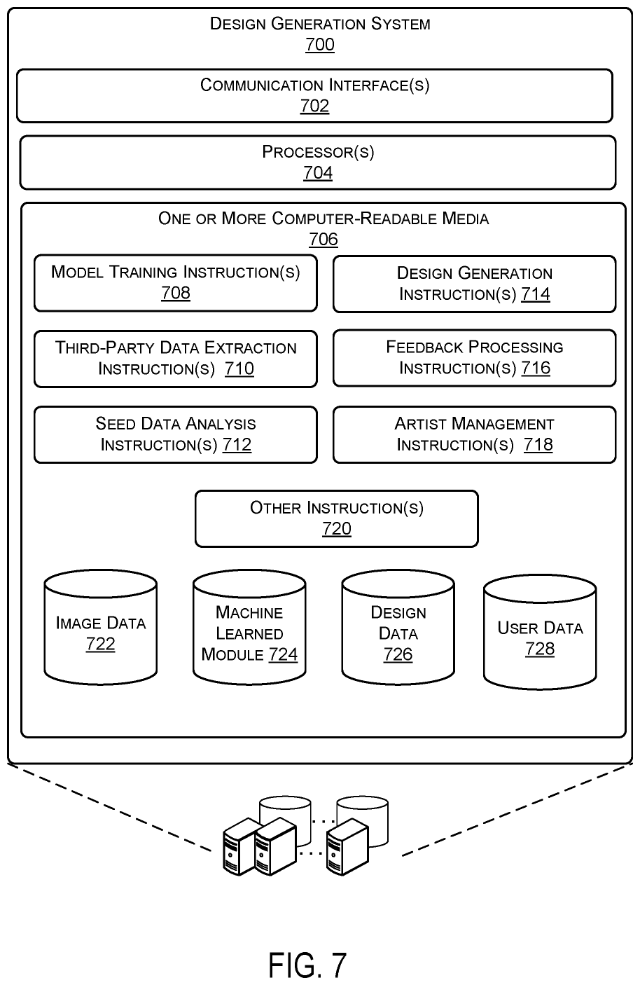

FIG. 7 is an example diagram of a cloud-based service associated with the design generation system 700 according to some implementations. The design generation system 700 may include one or more communication interface(s) 702 (also referred to as communication devices and/or modems). The one or more communication interfaces(s) 702 may enable communication between the design generation system 700 and one or more other local or remote computing device(s) or remote services. For instance, the communication interface(s) 702 can facilitate communication with end user devices and/or third-party systems, as discussed herein. The communications interfaces(s) 702 may enable Wi-Fi-based communication such as via frequencies defined by the IEEE 802.11 standards, short range wireless frequencies such as Bluetooth, cellular communication (e.g., 2G, 3G, 4G, 5G, 4G LTE, 6G, etc.), satellite communication, dedicated short-range communications (DSRC), ethernet, or any suitable wired or wireless communications protocol that enables the respective computing device to interface with the other computing device(s).

The design generation system 700 may include one or more processor(s) 704 and one or more computer-readable media 706. Each of the processors 704 may itself comprise one or more processors or processing cores. The computer-readable media 706 is illustrated as including memory/storage. The computer-readable media 706 may include volatile media (such as random access memory (RAM)) and/or nonvolatile media (such as read only memory (ROM), Flash memory, optical disks, magnetic disks, and so forth). The computer-readable media 706 may include fixed media (e.g., GPU, NPU, RAM, ROM, a fixed hard drive, and so on) as well as removable media (e.g., Flash memory, a removable hard drive, an optical disc, and so forth). The computer-readable media 706 may be configured in a variety of other ways as further described below.

Several modules such as instructions, data stores, and so forth may be stored within the computer-readable media 706 and configured to execute on the processors 704. For example, as illustrated, the computer-readable media 706 stores data model training instructions 708, third party data extraction instructions 710, seed data analysis instructions 712 (such as classification, segmentation, feature extraction, and the like), design generation instructions 714, feedback processing instructions 716, artist management instructions 718 as well as other instructions 720, such as an operating system. The computer-readable media 706 may also be configured to store data, such as image data 722, machine learned models 724, design data 726, user data 728, as well as other types of data.

The data model training instructions 708 may be configured to assist with training the various models for generating designs, recommending artist, generating human models, fitting designs to models, and the like.

The third-party data extraction instructions 710 may be configured to identify and/or generate training data for the models based on publicly available and license free images of various tattoos and/or body art. In some cases, the third-party data extraction instructions 710 may include one or more WebCrawler.

The seed data analysis instructions 712 may be configured to assist the user in providing the seed data to the system. For example, the seed data analysis instructions 712 may make recommendations or present queries to the user based on prior inputs by the user and/or other users.

The design generation instructions 714 may be configured to generate one or more designs based on the seed data provided by the user. For example, the design generation instructions 714 may include one or more machine learned models, heuristic based systems, comparison systems, and the like.

The feedback processing instructions 716 may be configured to generate updated seed data for a user based on feedback received to a prior set of generated designs. For example, the feedback processing instructions 716 may refine a setting, machine learned model, or the seed data itself based on feedback of a prior iteration of designs provided to the user. For example, if a first set of designs included multiple lion tattoos and the user selected a set that included only male lions with full manes, then the feedback processing instructions 716 may adjust the seed data from all lions to fully grown male lions.

The artist management instructions 718 may be configured to allow artists to generate portfolios or profiles that may be shared with users. The artist management instructions 718 may also be configured to assist in selecting artist for recommending to various users on one or more criteria, as discussed herein.

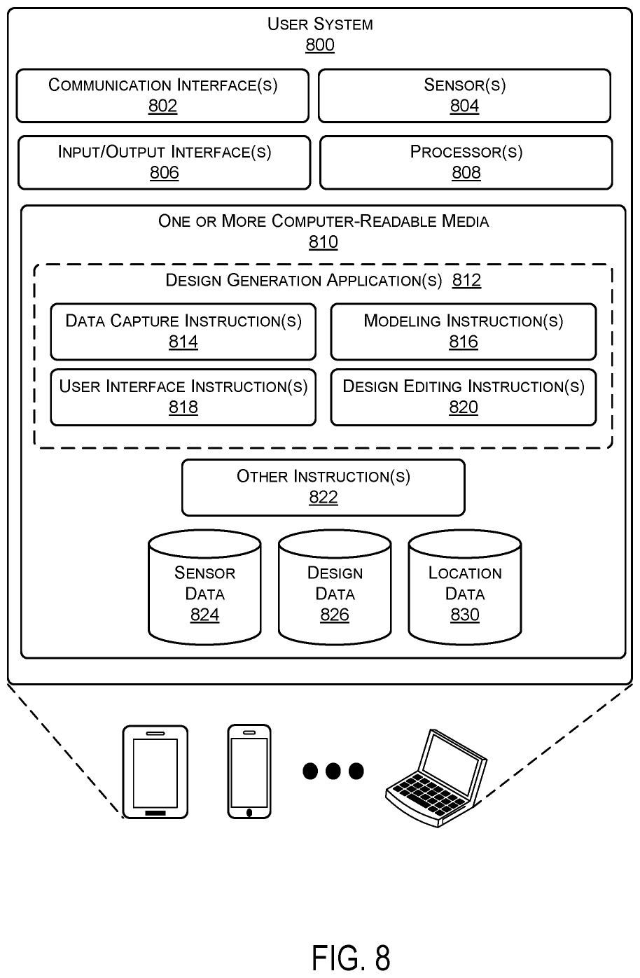

FIG. 8 is an example diagram of a user system 800 hosting a design generation application 812 associated with the design generation system of FIGS. 1-7 according to some implementations. The user system 800 may include one or more communication interfaces(s) 802 that enable communication between the system 800 and one or more other local or remote computing device(s) or remote services, such as the design generation system of FIGS. 1-7. For instance, the communication interface(s) 802 can facilitate communication with other proximity sensor systems, a central control system, or other facility systems. The communications interfaces(s) 802 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The user system 800 may include one or more sensor(s) 804 that may be configured to capture the sensor data (such as image data of the user, image data of a design, and the like). In at least some examples, the sensor(s) 804 may include image devices, depth sensors, location sensors, cameras (e.g., RGB, IR, intensity, depth, etc.), light sensors, wireless sensors, and the like. In some examples, the sensor(s) 804 may include multiple instances of each type of sensor. For instance, camera sensors may include multiple cameras disposed at various locations and configured to capture still images and video data.

The user system 800 may include one or more input/output interfaces 806. The input/output interfaces 806 may be configured to receive inputs and/or data from the user, such as textual descriptors, option selections, and the like as well as to provide or present information to a user, such as via one or more displays. In some cases, the input/output interfaces 806 may be a combined interface, such as a touch-enabled display.

The user system 800 may include one or more processors 808 and one or more computer-readable media 810. Each of the processors 808 may itself comprise one or more processors or processing cores. The computer-readable media 810 is illustrated as including memory/storage. The computer-readable media 810 may include volatile media (such as random access memory (RAM)) and/or nonvolatile media (such as read only memory (ROM), Flash memory, optical disks, magnetic disks, and so forth). The computer-readable media 810 may include fixed media (e.g., GPU, NPU, RAM, ROM, a fixed hard drive, and so on) as well as removable media (e.g., Flash memory, a removable hard drive, an optical disc, and so forth). The computer-readable media 810 may be configured in a variety of other ways as further described below.

Several modules such as instructions, data stores, and so forth may be stored within the computer-readable media 810 and configured to execute on the processors 808. For example, as illustrated, the computer-readable media 810 stores a design generation application 812 that may be configured to enable design generations in connection to the cloud-based design generation system of FIGS. 1-7. The design generation application 812 may also include additional modules, such as data capture instructions 814 to capture user inputs associated with a design, as discussed herein, modeling instructions 816 to assist with presenting a model (such as a 2D or 3D model of a selected designs on a human model), user interface instructions 818 to present data to a user (such as multiple designs) and/or receive data from the user (such as textual descriptors of a desired design), design editing instructions 820 to assist the user with adjusting or editing one or more designs (e.g., position, sizing, orienting, and the like the designs with respect to a model of their body), as well as other instructions 822, such as an operating system. The computer-readable media 810 may also be configured to store data, such as sensor data 824 (e.g., image data of the user) and design data 826 (e.g., images similar to the desired design, textual descriptors, option selection, and the like associated with the desired design, and the like), and location data 830 as well as other data.

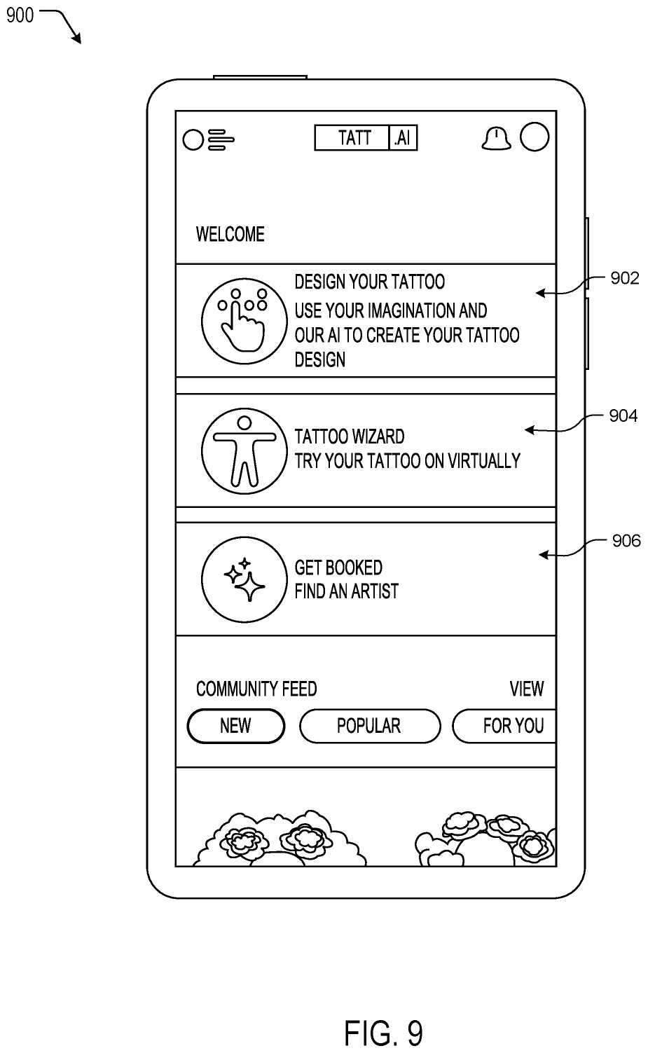

FIG. 9 is an example pictorial diagram illustrating an example portion of a user interface 900 of a design generation application associated with the design generation system of FIGS. 1-7 according to some implementations. In the current example, the user interface 900 may include a design option 902 to allow the user to initiate creation of one or more designs. For example, a user may select the design your tattoo option or the tattoo wizard option 904 to begin the design creation process. In the current example, the user interface 900 may also include an option to book an appointment or find an artist 906. The find an artist option 906 may begin the process of recommending an artist to apply a design generated by the design generation system, discussed herein, or to finalize a design based on the design generated by the design generation system.

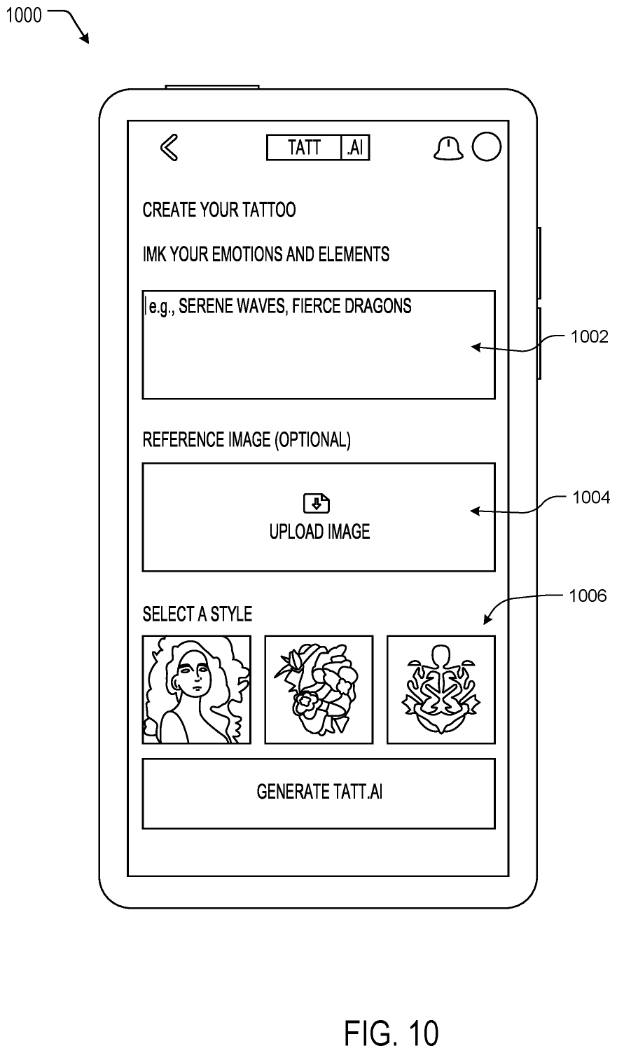

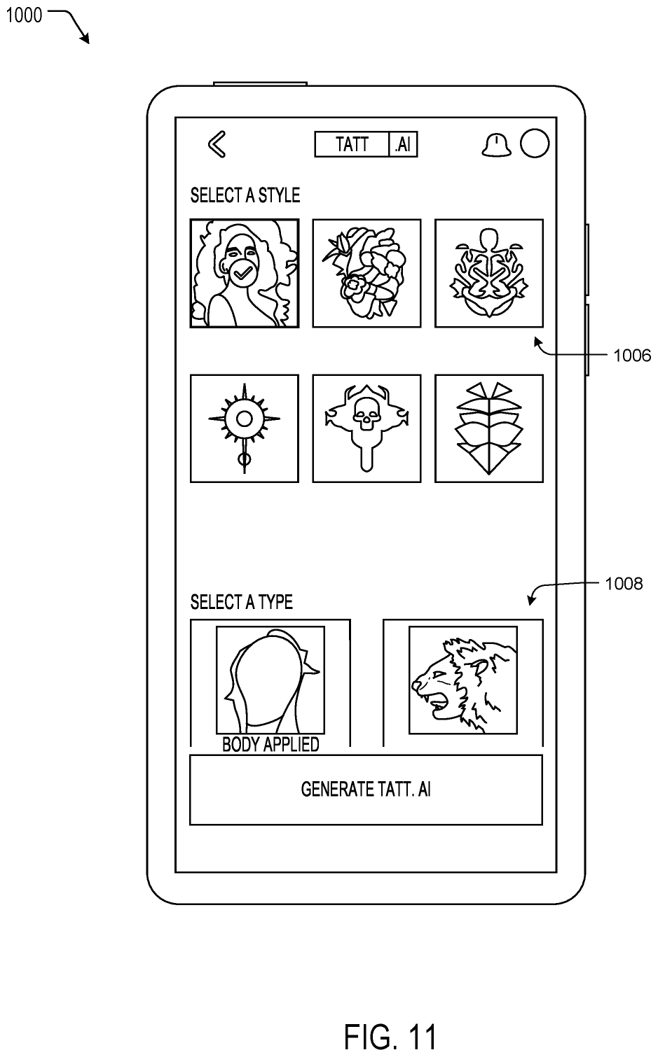

FIGS. 10 and 11 are example pictorial diagram illustrating an example portion of a user interface 1000 of a design generation application associated with the design generation system of FIGS. 1-7 according to some implementations. In the current example, the user may have selected the design option 902 or the wizard option 904 of FIG. 9. Accordingly, the user interface 1000 may allow the user to enter one or more textual descriptors within a textual descriptor input region 1002. In the current example, the textual descriptor input region 1002 may provide example descriptors to the user to assist the user in understanding the type and content of the descriptors that the system is expecting. The user interface 1000 may also include an upload image option 1004 to allow the user to provide one or more reference images for the system to utilize when generating potential designs. In the current example, the user interface 1000 may also include a style option 1006 to allow the user to select between various common styles of body art. The user interface 1000 may also include a type or body part option 1008 to allow the user to select a body part upon which the design will be applied.

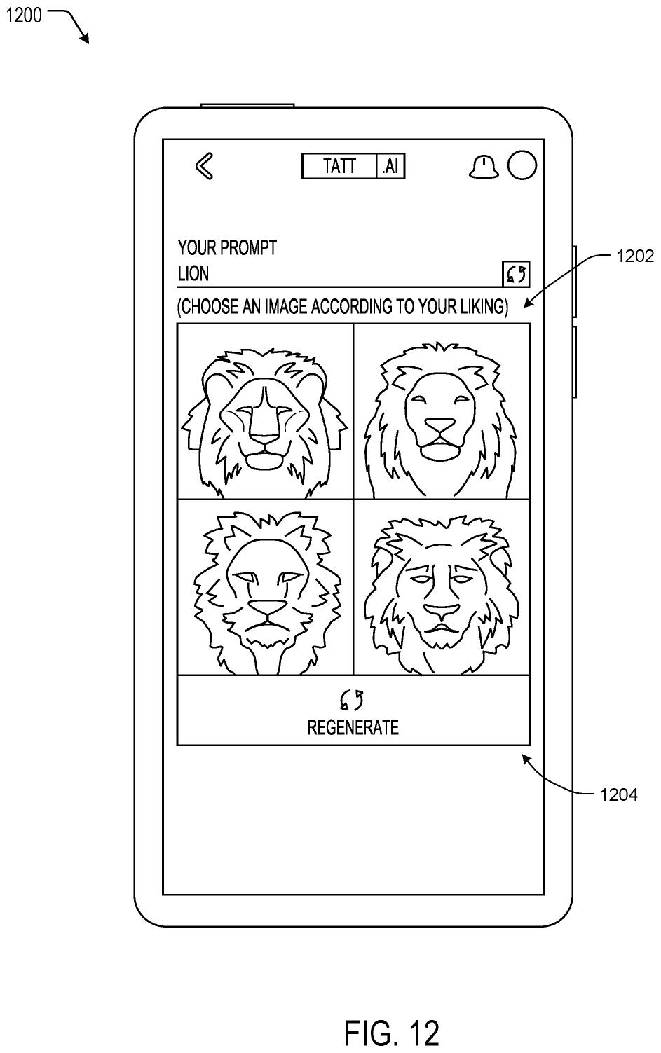

FIG. 12 is an example pictorial diagram illustrating an example portion of a user interface 1200 of a design generation application associated with the design generation system of FIGS. 1-7 according to some implementations. In the current example, the system has generated four designs that are presented to the user based on the user inputs (e.g., style, design location or body part, textual descriptors (in the current example “lion”), and the like). The generated designs may be present in a design selection window 1202 as shown. In some cases, the user may regenerate or start over with the same input data by selecting the regeneration option 1204.

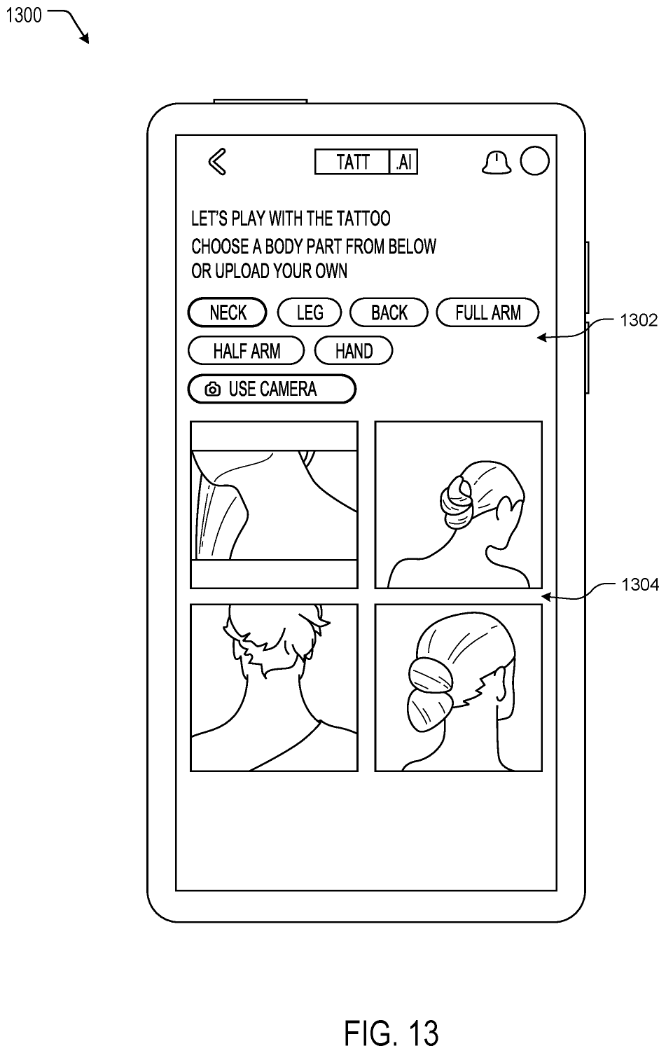

FIG. 13 is an example pictorial diagram illustrating an example portion of a user interface 1300 of a design generation application associated with the design generation system of FIGS. 1-7 according to some implementations. In the current example, the user interface 1300 may allow a user to place or otherwise display the tattoo or body art of one or more of the designs presented with respect to FIG. 12 on a body. As discussed above, the body model may be 2D or 3D and may in some cases be the body of the user. In the current example, the model is multiple 2D images of various body parts that may be changed via the body location selection options 1302. In the current example, in response to a selection of the “neck” option, the user interface 1300 may display multiple 2D neck models, generally indicated as selectable models 1304, that a user may select to view the one or more of the designs on.

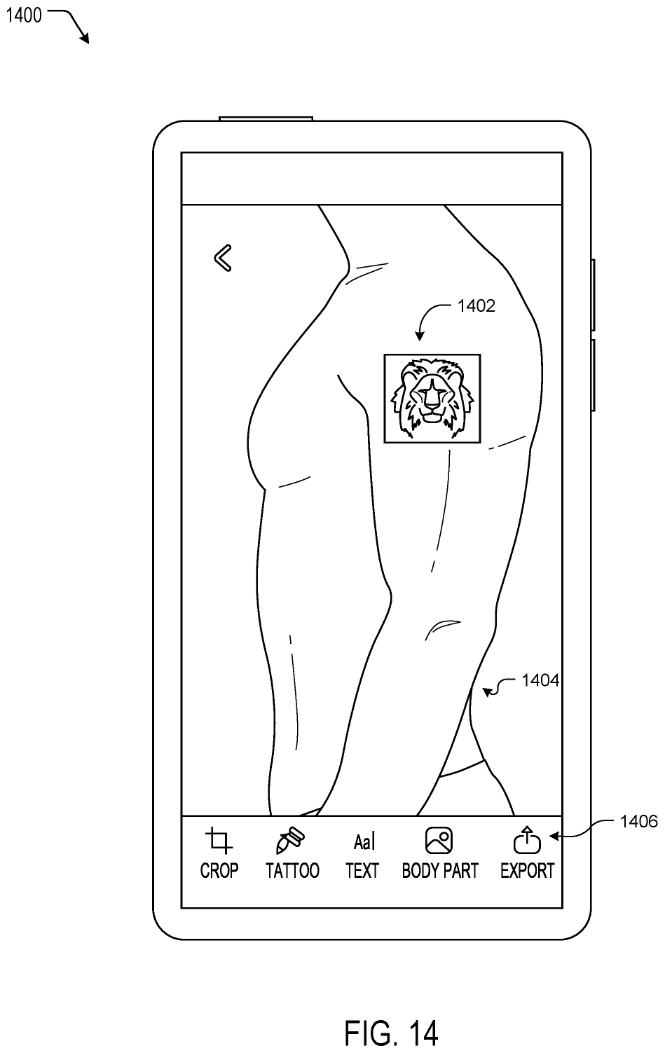

FIG. 14 is an example pictorial diagram illustrating an example portion of a user interface 1400 of a design generation application associated with the design generation system of FIGS. 1-7 according to some implementations. For example, the user interface 1400 may be displayed in response to a user selection of an arm model with respect to user interface 1300, discussed above. In the current example, a selected design 1402 is shown as applied to the selected model 1404. The user may utilize a touch or mouse input to move the design 1402 with respect to the model 1404. In some cases, the user may also rotate the model 1404 to view the design 1402 on the model 1404 from various different angles.

In the current example, the user interface 1400 may also include selectable options 1406 to edit the design 1402 or the model 1402. For example, the user may crop the design 1402, add text to the design 1402, change the model 1404, or the like. In some cases, the selectable options 1406 to edit the design 1402 may be controlled via touch inputs, such as two finger actions (e.g., pulling apart to increase size or sliding together to decrease size, single finger actions, swipes, circles, and the like).

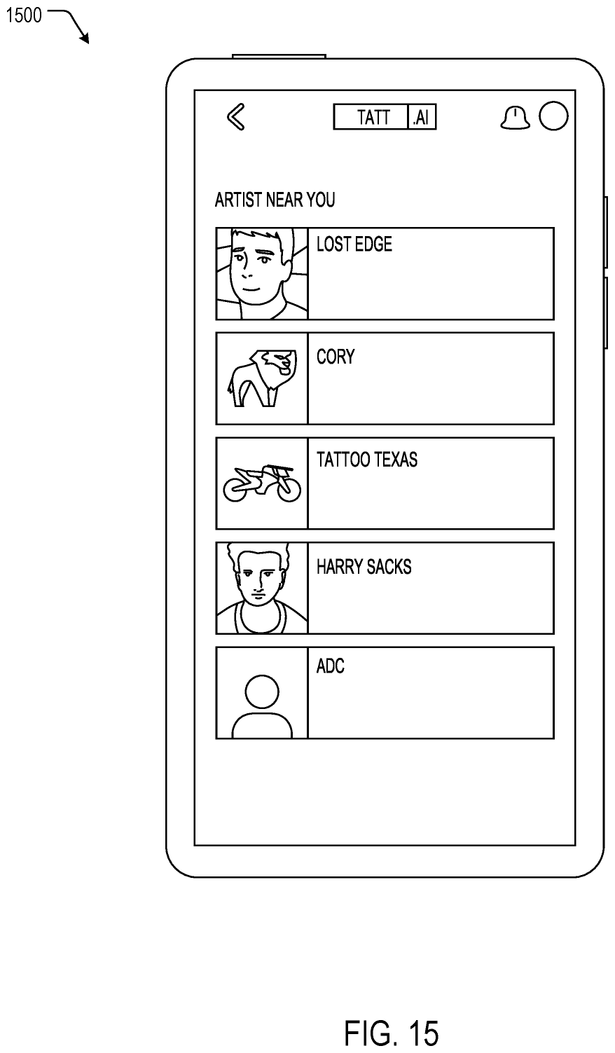

FIG. 15 is an example pictorial diagram illustrating an example portion of a user interface 1500 of a design generation application associated with the design generation system of FIGS. 1-7 according to some implementations. As discussed above, the design generation system may also provide features to recommend or match artists with the user. As illustrated, the user interface 1500 may generate a list of recommended artists based on geographical distance from the user. For example, the system may utilize a location or GPS position of the user device or system (e.g., the system of FIG. 8) and a known location of each artist to determine if the artist should be recommended. In other examples, the system may also consider other data in recommending the artists in user interface 1500. For instance, the user may filter based on price, style, years of experience, and the like.

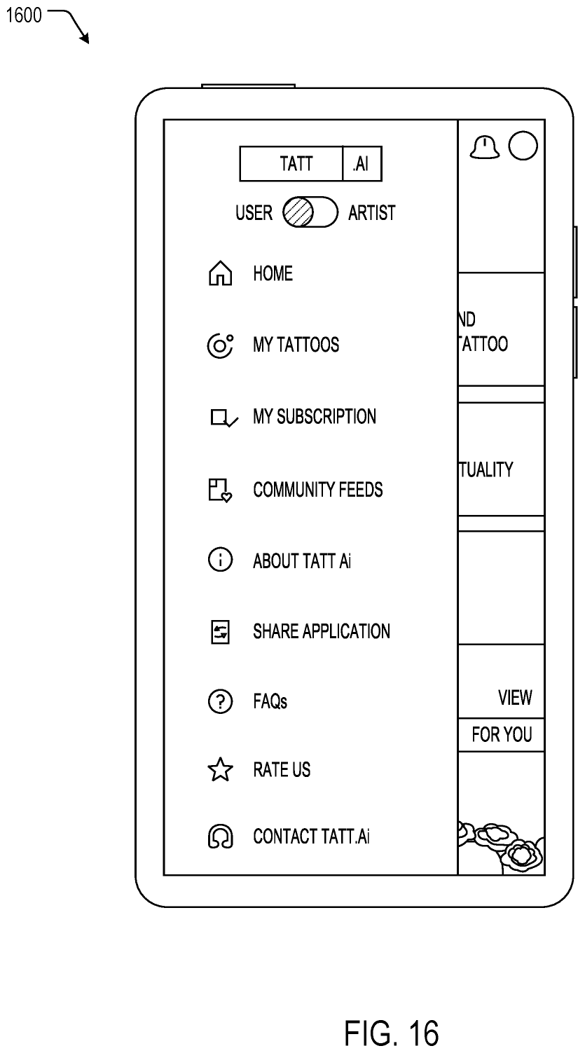

FIG. 16 is an example pictorial diagram illustrating an example portion of a user interface 1600 of a design generation application associated with the design generation system of FIGS. 1-7 according to some implementations. The user interface 1600 may allow a user (e.g., individual desiring a design) or an artist to create a profile, generate designs, add subscription services, update community information, and the like. For example, an artist profile may include information that may be consumed by a user in order to make a decision on if the user desires to hire the artist for application of one or more designs.

Although the subject matter has been described in language specific to structural features, it is to be understood that the subject matter defined in the appended claims is not necessarily limited to the specific features described. Rather, the specific features are disclosed as illustrative forms of implementing the claims.

### EXAMPLE CLAUSES

A. A method comprising: receiving, from a user device, a first textual descriptor; receiving, from the user device, a selection of a design location, the design location representative of a location relative to a human body; generating, based at least in part on the first textual descriptors, a first design, the first design representing body art; rendering a first model of the first design on image data of the human body at the design location; and causing the user device to present the first model on a display of the user device.

B. The method of A, further comprising determining, based at least in part on a geographical location of the user device, one or more artist; and providing to the user device information associated with each of the one or more artists.

C. The method of B, further comprising receiving, from the user device, a selection of a selected artist from the one or more artists; and providing the first design to a system associated with the selected artist.

D. The method of A, wherein generating the first design further comprises inputting the textual descriptors into a first machine learned model, the first machine learned model trained on body art, textual descriptors, and pairs of prior designs generated by the first machine learned model and selection of the prior designs by a user for application to a body of the user; and receiving, as an output of the first machine learned model, the first design.

E. The method of A, wherein receiving the design location representative of the location relative to the human body further comprises receiving image data of a user associated with the user device; and rendering the first model of the first design on image data of the human body at the design location further comprises generating the first model based at least in part on the image data of the user.

F. The method of claim 1, further comprising generating, based at least in part on the first textual descriptors, a second design, the second design representing body art; and rendering a second model of the second design on the image data of the human body at the design location.

G. The method of F, further comprising receiving, from the user device, a selection of the first design prior to causing the user device to present the first model on the display of the user device.

H. The method of F, further comprising causing the user device to present the second model on the display of the user device.

I. The method of F, further comprising receiving, from the user device, a selection of the first design; generating, based at least in part on the first textual descriptors and the first design, a third design representing body art; rendering a second model of the third design on the image data of the human body at the design location; and causing the user device to present the third model on the display of the user device.

J. The method of A, further comprising receiving, from the user device, an image; and wherein generating the first design is based at least in part on the image and the first textual descriptors.

K. A system comprising: one or more processors; one or more communication interfaces; and one or more computer-readable media storing instructions that, when executed by the one or more processors, cause the one or more processors to perform operations comprising: receiving, from a user device, a first image; receiving, from the user device, a selection of a design location, the design location representative of a location relative to a human body; generating, based at least in part on the first image, a first design, the first design representing body art; rendering a first model of the human body including the design location; and providing the first model and the first design to the user device.

L. The system of K, wherein the operations further comprise causing one or more example descriptors to be presented on the display of the user device prior to receiving the image.

M. The system of K, wherein the operations further comprise receiving, from a user device, a first textual descriptors; and generating the first design is based at least in part on the first textual descriptors and the first image.

N. The system of K, wherein the operations further comprise causing, the user device, to present the first design with respect to the first model on a display of the user device; receiving a user input associated with the first design; and responsive to receiving the user input, adjusting at least one parameter of the first design with respect to the first model.

O. The system of N wherein the at least one parameter is one of the following: a dimension of the first design; an orientation of the first design; a position of the first design relative to the first model; a color of the first design; a hue of the first design; a tone of the first design; or an axis of the first design relative to the first model.

P. One or more computer-readable media storing instructions that, when executed by one or more processors, cause the one or more processors to perform operations comprising: receiving, from a user device, a first textual descriptor; receiving, from the user device, a selection of a design location, the design location representative of a location relative to a human body; generating, based at least in part on the first textual descriptor, a first design, the first design representing body art; rendering a first model of the human body based at least in part on the selection of the design location; and proving the first model and the first design to the user device.

Q. One or more computer-readable media of P, wherein the operations further comprise receiving, from the user device, a desired style; and wherein generating the first design is based at least in part on the style.

R. One or more computer-readable media of Q, wherein the operations further comprise determining, based at least in part on the style, one or more artist; and providing to the user device information associated with each of the one or more artists.

S. One or more computer-readable media of P, wherein the first model is a three-dimensional model.

T. One or more computer-readable media of P, wherein the operations further comprise receiving, from a user device, a color palette; and generating the first design is based at least in part on the color palette.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, from a user device, a first textual descriptor;
receiving, from the user device, a selection of a design location, the design location representative of a location relative to a human body;
generating, based at least in part on the first textual descriptors, a first design, the first design representing body art;
rendering a first model of the first design on image data of the human body at the design location; and
causing the user device to present the first model on a display of the user device.

2. The method of claim 1, further comprising:
determining, based at least in part on a geographical location of the user device, one or more artist; and
providing to the user device information associated with each of the one or more artists.

3. The method of claim 2, further comprising:
receiving, from the user device, a selection of a selected artist from the one or more artists; and
providing the first design to a system associated with the selected artist.

4. The method of claim 1, wherein generating the first design further comprises:
inputting the textual descriptors into a first machine learned model, the first machine learned model trained on body art, textual descriptors, and pairs of prior designs generated by the first machine learned model and selection of the prior designs by a user for application to a body of the user; and
receiving, as an output of the first machine learned model, the first design.

5. The method of claim 1, wherein:
receiving the design location representative of the location relative to the human body further comprises receiving image data of a user associated with the user device; and
rendering the first model of the first design on image data of the human body at the design location further comprises generating the first model based at least in part on the image data of the user.

6. The method of claim 1, further comprising:
generating, based at least in part on the first textual descriptors, a second design, the second design representing body art; and
rendering a second model of the second design on the image data of the human body at the design location.

7. The method of claim 6, further comprising receiving, from the user device, a selection of the first design prior to causing the user device to present the first model on the display of the user device.

8. The method of claim 6, further comprising causing the user device to present the second model on the display of the user device.

9. The method of claim 6, further comprising:
receiving, from the user device, a selection of the first design;
generating, based at least in part on the first textual descriptors and the first design, a third design representing body art;
rendering a second model of the third design on the image data of the human body at the design location; and
causing the user device to present the third model on the display of the user device.

10. The method of claim 1, further comprising:
receiving, from the user device, an image; and
wherein generating the first design is based at least in part on the image and the first textual descriptors.

11. A system comprising:
one or more processors;
one or more communication interfaces; and
one or more computer-readable media storing instructions that, when executed by the one or more processors, cause the one or more processors to perform operations comprising:
receiving, from a user device, a first image;
receiving, from the user device, a selection of a design location, the design location representative of a location relative to a human body;
generating, based at least in part on the first image, a first design, the first design representing body art;
rendering a first model of the human body including the design location; and
providing the first model and the first design to the user device.

12. The system of claim 11, wherein the operations further comprise causing one or more example descriptors to be presented on the display of the user device prior to receiving the image.

13. The system of claim 11, wherein:
the operations further comprise receiving, from a user device, a first textual descriptors; and
generating the first design is based at least in part on the first textual descriptors and the first image.

14. The system of claim 11, wherein the operations further comprise:
causing, the user device, to present the first design with respect to the first model on a display of the user device;
receiving a user input associated with the first design; and
responsive to receiving the user input, adjusting at least one parameter of the first design with respect to the first model.

15. The system of claim 14, wherein the at least one parameter is one of the following:
a dimension of the first design;
an orientation of the first design;
a position of the first design relative to the first model;
a color of the first design;
a hue of the first design;
a tone of the first design; or
an axis of the first design relative to the first model.

16. One or more computer-readable media storing instructions that, when executed by one or more processors, cause the one or more processors to perform operations comprising:
receiving, from a user device, a first textual descriptor;
receiving, from the user device, a selection of a design location, the design location representative of a location relative to a human body;
generating, based at least in part on the first textual descriptor, a first design, the first design representing body art;
rendering a first model of the human body based at least in part on the selection of the design location; and
proving the first model and the first design to the user device.

17. One or more computer-readable media of claim 16, wherein the operations further comprise:
receiving, from the user device, a desired style; and
wherein generating the first design is based at least in part on the style.

18. One or more computer-readable media of claim 17, wherein the operations further comprise:
determining, based at least in part on the style, one or more artist; and
providing to the user device information associated with each of the one or more artists.

19. One or more computer-readable media of claim 16, wherein the first model is a three-dimensional model.

20. One or more computer-readable media of claim 16, wherein:
the operations further comprise receiving, from a user device, a color palette; and
generating the first design is based at least in part on the color palette.
